(19) United States
(12) Patent Application Publication
(10) Pub. No.: US 2008/0185826 A1
(43) Pub. Date: Aug. 7, 2008

(54) Smart Airbag Interface

(75) Inventors: Ian Hall, Ann Arbor, MI (US); David Tippy, Ann Arbor, MI (US); Sean Ryan, Farmington Hills, MI (US)

Correspondence Address: BUTZEL LONG;IP DOCKETING DEPT, 350 SOUTH MAIN STREET, SUITE 300, ANN ARBOR, MI, 48104, US

(73) Assignee: FORD GLOBAL TECHNOLOGIES, LLC, Dearborn, MI (US)

(21) Appl. No.: 11/670,014

(22) Filed: Feb. 1, 2007

(51) Int. Cl. B60R 21/01

(52) U.S. Cl. 280/735

(57) ABSTRACT

A system and method for regulating the deployment of an airbag inflator in response to an out-of-position occupant is provided. An airbag tether is operatively associated with a tether position sensor which is itself operatively associated with a restraints control module (RCM) through an interface. Upon normal in-position deployment, the primary surface of the airbag cushion deploys car-rearward. In this event the tether acts on the tether position sensor at a normal time. If the airbag cushion contacts an out-of-position occupant, the expansion of the airbag cushion will be slowed and the tether will act on the tether position sensor at a later time. The resistor element signals the RCM of the slowed airbag expansion and, with this information, the RCM may decide to modify the deployment of the airbag by adjusting the inflator's second stage deployment time delay. The decision criteria for the deployment of the second inflator are thus time-based.

### TECHNICAL FIELD

The present invention relates generally to a vehicle occupant restraint system and, more particularly, relates to an interface that allows an airbag system module to modify the deployment time delay of the airbag based upon the position of the passenger.

### BACKGROUND OF THE INVENTION

Automotive vehicles incorporate a variety of restraint systems to provide for the safety of occupants. These systems are generally included to reduce the likelihood of injury to the occupants in a crash event. Common safety systems include front airbags, side airbags, and seatbelts. The airbags are deployed within a vehicle and expand within the passenger compartment in a crash event to serve as a cushion between the occupant and interior vehicle components such as the steering wheel, the instrument panel and the windshield.

Selective and inflatable expansion of the airbag is regulated by an impact sensing system of controllers and sensors which activate the airbags in response to a vehicle collision. Particularly, the impact sensing system typically includes impact sensors and a restraints control module (RCM). The airbag inflators are operatively connected to the RCM. Some airbags assemblies are fitted with “dual stage” inflators which are capable of discharging gas into the airbag at two or more separate rates or output levels using a first stage inflator and a second stage inflator. If a crash event is detected by one or more of the impact sensors, a collision signal is sent from the impact sensors to the RCM. The RCM then determines whether or not to activate the inflator.

Once the decision is made by the RCM to activate the inflator, a predetermined, specific amount of inflating gas is ordinarily released into the airbag cushion and it is inflated to a pre-established size. In an effort to customize the amount of gas released into the airbag or to modify the position of the airbag itself, various changes have been made to the basic airbag. Such modifications result in “smart airbags” and incorporate a system that, for example, is able to respond to occupants of different sizes and types through seat-based sensors or other sensors fitted within the vehicle cabin. A newer approach to sensing the type and size of the occupant includes placing sensors in the airbag itself. Some of these systems enable suppression or modification of the action of the second stage inflator.

However, little has been done to differentiate between an in-position occupant and an out-of-position (“OOP”) occupant. As a result, the same amount of airbag-expanding gas is released by the inflator without accounting for the position of the vehicle occupant, this in spite of the fact that the out-of-position occupant may not require the same level of deployment energy as compared to the in-position occupant. It would be desirable to have an effective airbag system that identifies the position of the vehicle occupant and responds by adjusting the amount of gas released into the airbag cushion. Therefore, there is a need in the art to provide a method and a system for identifying the position of the occupant and to have the airbag respond accordingly.

### SUMMARY OF THE INVENTION

The present invention provides an airbag system that senses the position of the vehicle occupant and adjusts the amount of gas released into the airbag cushion in accordance with the sensed position by changing the airbag deployment strategy.

In its preferred embodiment the airbag system of the present invention includes a resistor sensing element integrated in a tether position sensor that is operatively associated with an airbag tether. The tether position sensor is itself operatively associated with the restraints control module (RCM) through an interface. Upon normal in-position occupant deployment, the primary surface of the airbag cushion deploys car-rearward. In this event the tether pulls the resistor element at a normal time. In the event the airbag cushion contacts an out-of-position occupant, the expansion of the airbag cushion is slowed and the tether pulls the resistor element of the tether position sensor at a later time. The resistor element signals the RCM of the slowed airbag expansion and, with this information, the RCM may decide to modify the deployment of the airbag by adjusting the inflator's second stage deployment time delay. Accordingly, part of the decision criteria for the deployment of the second inflator is based on time, in addition to other impact and occupant characteristics.

By providing an interface between the electrical components of the airbag and the RCM that is capable of responding to the position of the occupant, the present invention provides a smart airbag response to the out-of-position occupant. The arrangement set forth herein allows for the installation of a smart airbag into a vehicle with little or no impact on the central airbag electronic control unit.

The present invention also provides a diagnostic method for determining the status of the airbag tether position sensor.

The diagnostics and airbag control functionality may be further enhanced by including more sensors.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 shows a schematic side view of a vehicle occupant restraint system including a deployed airbag and an in-position occupant;

FIG. 2 shows the side view of FIG. 1 but with an out-of-position occupant;

FIG. 3 shows a diagram of a resistive sensor of the tether position sensor used in the airbag system of the present invention with both the tether position sensor and the self-test diagnostics sensor in their closed positions;

FIG. 4 shows a diagram of the resistive sensor of FIG. 3 at a certain time limit in an in-position airbag deployment event;

FIG. 5 shows the diagram of the resistive sensor of FIG. 4 at a certain time in an out-of-position occupant airbag deployment event;

FIG. 6 is a schematic illustrating the circuit of the tether position sensor, the transmitter-receiver interface, and the restraints control module; and

FIG. 7 is a graph illustrating the tether sensor signals for both in-position and out-of-position occupants with voltage on the Y-axis and time on the X-axis.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

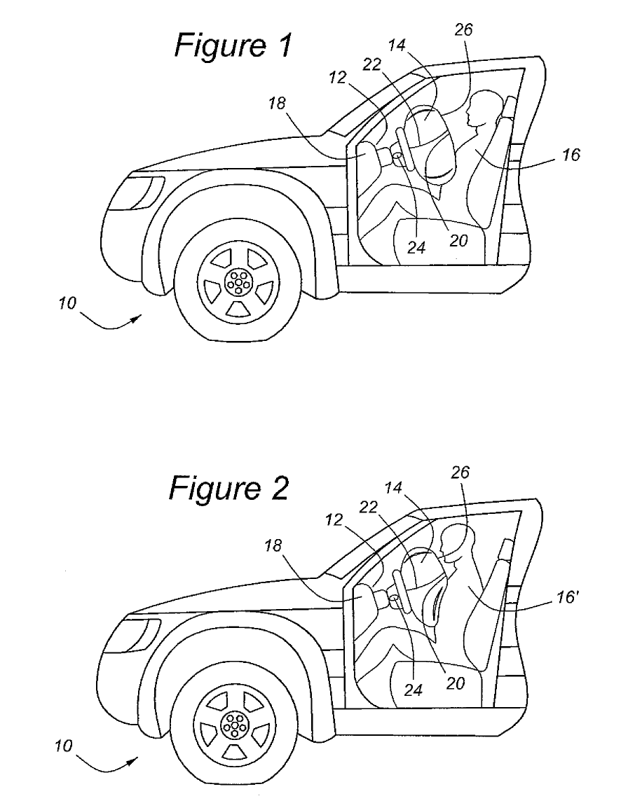

Referring now to FIG. 1, there is shown a schematic side view of a vehicle, generally illustrated as 10, having an occupant restraint system, generally illustrated as 12. The restraint system 12 includes an airbag cushion 14 shown deployed between an in-position occupant 16 and an instrument panel/steering wheel 18 of the vehicle 10. It should be understood that while a steering-wheel mounted airbag is illustrated the present invention is suitable as well for all vehicle airbags. Furthermore, while an automotive vehicle is illustrated it should be understood that the airbag system of the present invention will find application as well in other vehicles, including sport-utility vehicles, recreational vehicles, and in both light and heavy trucks.

The airbag cushion 14 includes a far internal wall 20. A tether 22 connects the far internal wall 20 of the airbag cushion 14 to a tether position sensor assembly 24. The tether position sensor assembly 24 incorporates the resistor sensing element and is fitted to the airbag housing (not shown) mounted in the instrument panel/steering wheel 18. The airbag cushion 14 also includes a primary surface 26.

While in-position seating of the occupant is preferred while the vehicle is underway, the occupant may choose to sit in an out-of-position condition. Such a scenario is illustrated in FIG. 2, where an out-of-position occupant 16′ is shown spaced-apart from the seat back. FIGS. 1 and 2 clearly illustrate that a lower level of deployment energy may benefit for the out-of-position occupant.

As set forth above, the airbag system of the present invention can reduce the deployment energy of the inflator to prevent the application of more energy than is needed for occupant restraint during a crash event. Particularly, upon normal in-position deployment of the airbag cushion 14 as illustrated in FIG. 1, the primary surface 26 will deploy rearward and the tether 22 will pull the tether position sensor assembly 24 at an in-position time (Time=Tₙₒᵣₘₐₗ). If the airbag cushion 14 contacts the out-of-position occupant 16′ as illustrated in FIG. 2, then the travel of the airbag cushion 14 will slow, and the tether 22 will pull the tether position sensor assembly 24 at a later, out-of-position time (Time=Tₙₒᵣₘₐₗ+T_{delay}). The tether position sensor assembly 24 will then send a signal to a restraints control module (discussed below). The restraints control module will then decide whether or not to modify the deployment of the airbag 14.

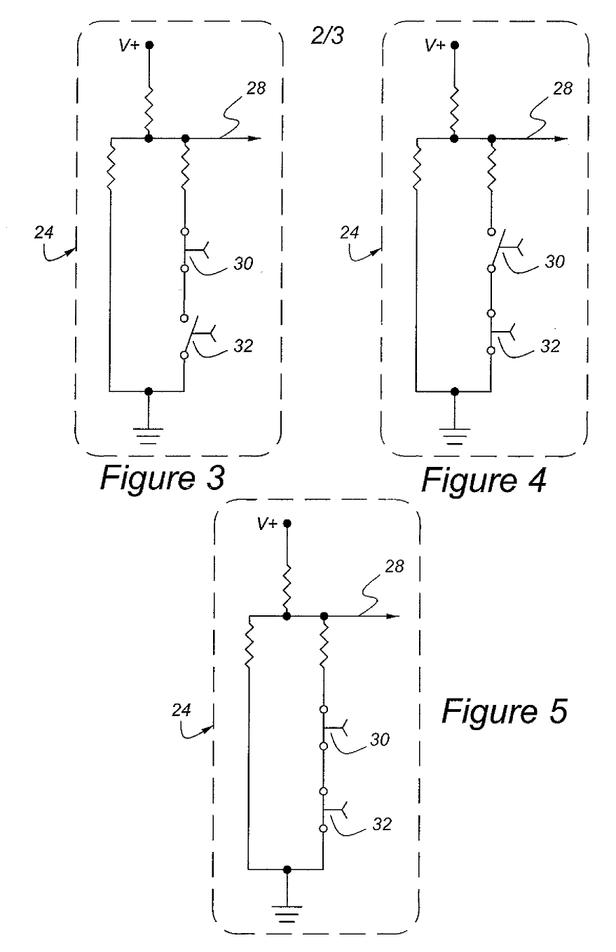

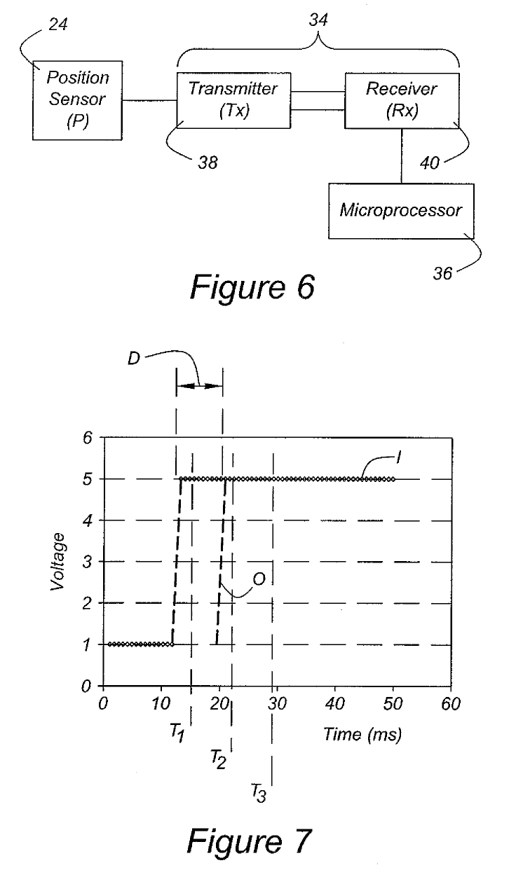

FIGS. 3 through 5 illustrate diagrams of the resistor sensing element of the tether position sensor assembly 24 of the present invention in engaged and disengaged modes. In all of these diagrams a regulated voltage (V+) is provided by the restraints control module (RCM) (shown in FIG. 6 and described in conjunction therewith). The sensing voltage 28 is provided to the system interface (also shown in FIG. 6 and described in conjunction therewith).

Referring first to FIG. 3, the resistor sensing element of the tether position sensor assembly 24 is shown, by way of general example, with a tether position sensor 30 in its closed position and a diagnostics sensor 32 (discussed below) shown in its open position. FIG. 4 illustrates the position of the tether position sensor 30 where the circuit is open as would be the case at a certain time in an in-position airbag deployment event shown in FIG. 1. FIG. 5 illustrates the position of the tether position sensor 30 where the circuit is closed as it would be at a certain time in an out-of-position airbag deployment event shown in FIG. 2.

In the event of a collision, the airbag cushion 14 is deployed car-rearward. The tether 22 is pulled by the movement of the airbag cushion 14. The tether position sensor assembly 24 senses the position of the tether 22. If the airbag cushion 14 reaches a pre-selected position by a pre-selected time following deployment, then it is assumed that the airbag cushion 14 has not made contact with an out-of-position occupant. The tether position sensor assembly 24 will be in its “tether disengaged” or open position as illustrated in FIG. 4.

If, on the other hand, the airbag cushion 14 does not reach the pre-selected position by the pre-selected time after deployment, then it is assumed that the airbag cushion has contacted the out-of-position occupant 16′ of FIG. 2. The tether position sensor assembly 24 will be in its “tether engaged” or closed position as illustrated in FIG. 5.

The voltage of the “tether engaged” or closed position of FIG. 5 is lower than the voltage of the “tether disengaged” or open position of FIG. 4. In either event, the voltage 28 resulting from the tether position sensor assembly 24 is directed to an interface 34 which in turn provides information to a restraints control module (RCM) 36. The RCM 36 includes a conventional microprocessor or a microcontroller operating under stored program control. Based on the information received from the interface 34, the RCM 36 decides when to deploy the second state of the inflator. The RCM may decide to suppress the second stage of the inflator until a normal inflator disposal time, after the crash event.

The interface 34 comprises a transmitter 38 (which is operatively coupled with the tether position sensor assembly 24) and a receiver 40 (which is operatively coupled with the RCM 36). Diagnostics and communications of the status of the tether position sensor assembly 24 is accomplished through a plurality of wires that connect the sensor 24 (through the transmitter 38) and the RCM 36 (through the receiver 40). The plurality of wires (typically two) creates a current loop. The plurality of wires provides both power and the means to communicate the status to the RCM 36. The RCM 36 provides the regulated voltage (V+) to the tether position sensor assembly 24 from which the sensor assembly 24 obtains its operating current. More particularly, the tether position sensor assembly 24 communicates status information to the RCM 36 by modulating the current drawn from the RCM 36. Within the tether position sensor assembly 24 a transmitter ASIC 38 reads the analog voltage produced by the tether position sensing resistors (shown in FIGS. 3 through 5) and then digitally encodes the voltage in the current loop interface which is then communicated to the RCM 36. Accordingly, the transmitter 38 informs the receiver 40 when the circuit of the resistor sensing element of the tether position sensor assembly 24 opened.

The decision by the RCM 36 to deploy the second stage of the inflator is time-based. The time-based decision criteria for the deployment of the second inflator stage have multiple thresholds which correlate to multiple second stage delay times. For example, second stage delay times might comprise the following:

| Tether Sensor Signal | Change to 2^{nd} |
|---|---|
| Threshold (ms) | Stage Delay Time |
| t <= 15 | No change |
| 15 < t <= 22 | Increase 2^{nd} Stage Delay Time by 20 ms |
| 22 < t <= 29 | Increase 2^{nd} Stage Delay Time by 40 ms |
| 29 < t | Increase 2^{nd} Stage Delay Time by 100 ms |

These delay times are susceptible to a wide range of variations based on parameters including, for example, the distance from the instrument panel to the front of the seat back, the occupant classification and restraint status, the predicted crash severity and others.

Referring to FIG. 7, a graph illustrating multiple tether sensor signal thresholds is shown. The in-position tether sensor output voltage reaches its value prior to threshold T1 as illustrated by broken line “I”. In this case the second stage delay time would not be modified. In the event that the airbag cushion 14 contacts the out-of-position occupant 16′, the airbag cushion 14 demonstrates less car-rearward travel, as illustrated by broken line “O”. The time-delay in the tether sensor output voltage is illustrated as “D”. According to the exemplary second stage delay time, the time delay in the tether sensor output voltage would increase the second inflator stage deployment by 20 ms.

As may be understood by the above illustrations, the tether threshold is set such that it does not affect the in-position occupant 16. However, for the out-of-position occupant 16′, the tether threshold is selected so as to reduce the inflation energy relative to the amount of interaction with the airbag cushion 14. The out-of-position occupant 16′ accordingly experiences a more benign deployment of the airbag cushion 14.

The present invention also provides a simplified method of diagnosing the status of the tether position sensing interface by using a self-test actuation feature. This feature is actuated upon startup of the system and periodically during a key cycle. It permits the RCM 36 to confirm the functionality of the tether position sensor assembly 24. The diagnostic is capable of verifying proper function of the position sensor assembly 24, the interface 34, and the RCM 36 by exercising both output states of the tether position sensor assembly 24. A warning is provided to the operator in the event that any system failure is detected.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A system for modifying the deployment delay of an airbag cushion in a vehicle based upon the position of an occupant, the system comprising:
a tether fitted to the airbag cushion;
a tether position sensor connected to said tether, said tether position sensor providing output voltage based upon the position of said tether;
a restraints control module;
an inflator operatively associated with said restraints control module; and
an interface operatively associating said tether position sensor and said restraints control module to read and encode said output voltage of said tether position sensor, said interface further communicating said read and encoded voltage to said restraints control module,
whereby said restraints control module interprets said read and encoded voltage to determine if there has been a time-delay in movement of said tether and, based upon said determination, may regulate deployment of the airbag cushion through operation of said inflator.

2. The system of claim 1, wherein said tether position sensor includes a resistor sensing element, said tether being operatively associated with said resistor sensing element.

3. The system of claim 1, wherein said inflator is a dual-stage inflator comprising a first stage and a second stage, and wherein said restraints control module regulates operation of said second stage based upon time-based decision criteria.

4. The system of claim 1, wherein said interface comprises a transmitter and a receiver, said transmitter and said receiver being operatively connected.

5. The system of claim 2, wherein said resistor sensing element generates a voltage and wherein said interface reads said voltage generated by said resistor sensing element and digitally encodes said voltage for communication with said restraints control module.

6. The system of claim 1 wherein said tether position sensor is a first sensor and wherein the system further includes additional tether position sensors connected to said tether.

7. The system of claim 6 wherein said additional positions sensors provide output voltage based upon the positions of said tethers, whereby said voltage from said first tether position sensor and said voltage from said additional tether position sensors are compared against multiple time-based thresholds.

8. A system for modifying the deployment delay of an airbag cushion in a vehicle based upon the position of an occupant, the system comprising:
a sensor assembly for sensing the extent of travel of the airbag cushion when deployed, said sensor assembly providing an output voltage;
a restraints control module;
an inflator operatively associated with said restraints control module; and
an interface operatively associating said sensor assembly and said restraints control module to read and encode the output voltage of said sensor assembly,
whereby the read and encoded output voltage is interpreted by the system to determine if there has been a time-delay in the travel of the airbag cushion and, based upon said determination, the deployment of the airbag cushion may be regulated through operation of said inflator.

9. The system of claim 8, wherein said sensor assembly for sensing the extent of travel comprises a tether fitted to the airbag cushion and a tether position sensor connected to said tether.

10. The system of claim 8, wherein said restraints control module interprets said read and encoded voltage to make said determination to regulate the deployment of the airbag cushion.

11. The system of claim 9, wherein said tether position sensor includes a resistor sensing element, said tether being operatively associated with said resistor sensing element.

12. The system of claim 11, wherein said resistor sensing element generates a voltage and wherein said interface reads said voltage generated by said resistor sensing element and digitally encodes said voltage for communication with said restraints control module.

13. The system of claim 10, wherein said inflator is a dual-stage inflator comprising a first stage and a second stage, and wherein said restraints control module regulates operation of said second stage based upon time-based decision criteria.

14. The system of claim 8 wherein said tether position sensor is a first sensor and wherein the system further includes additional tether position sensors connected to said tether.

15. The system of claim 14 wherein said additional tether position sensors provide output voltage based upon the position of said tether, whereby said voltage from said first tether position sensor and said voltage from said additional tether position sensors are compared against multiple time-based thresholds.

16. A method of modifying the deployment delay of an airbag cushion in a vehicle based upon the position of an occupant, the method including the steps of:
forming a system for modifying the deployment delay of the airbag cushion, the system including a tether fitted to the airbag cushion, a tether position sensor connected to said tether for providing output voltage based upon the position of said tether, a restraints control module, an inflator operatively associated with said restraints control module, and an interface operatively associating said tether position sensor and said restraints control module for reading and encoding said output voltage of said tether position sensor;
effecting the generation of output voltage by said tether position sensor during a crash event, said output voltage being based upon the position of said tether during said crash event;
reading and encoding said output voltage;
communicating said read and encoded information to said restraints control module;
interpreting said read and encoded voltage to determine if there has been a time-delay in movement of said tether; and
regulating deployment of the airbag cushion through operation of said inflator according to time-based decision criteria.

17. The method of claim 16, wherein said resistor sensing element generates a voltage, the method including the steps of said interface reading said voltage generated by said resistor sensing element and digitally encoding said voltage for communication with said restraints control module

18. The method of claim 16, wherein said inflator includes a first stage and a second stage and wherein said step of regulating deployment of the airbag cushion through operation of said inflator includes the step of regulating deployment of said second stage.

19. The method of claim 16 wherein said tether position sensor is a first sensor and wherein the system further includes additional tether position sensors connected to said tether.

20. The method of claim 19 wherein said additional tether position sensors provide output voltage based upon the position of said tether, the method including the step of comparing said voltage from said first tether position sensor and the voltages from said additional tether position sensors against multiple time-based thresholds.
